(19) United States
(12) Patent Application Publication
(10) Pub. No.: US 2014/0143059 A1
(43) Pub. Date: May 22, 2014

(54) PROCESS, METHOD, SYSTEM AND APPARATUS FOR ACCESSING CONSUMERS TO IMPPROVE SALES, KNOWLEDGE AND ENGAGEMENT

(71) Applicants: Benjamin J. Kwitek, Canon City, CO (US); Harold S. Springer, Toronto (CA)

(72) Inventors: Benjamin J. Kwitek, Canon City, CO (US); Harold S. Springer, Toronto (CA)

(21) Appl. No.: 14/085,287

(22) Filed: Nov. 20, 2013

Related U.S. Application Data
(60) Provisional application No. 61/728,289, filed on Nov. 20, 2012.

(51) Int. Cl. G06Q 30/02

(52) U.S. Cl. CPC G06Q 30/0267; G06Q 30/0261
USPC 705/14.58; 705/14.64

(57) ABSTRACT

A system for accessing consumers before, during and after purchase decisions includes a plurality of electronic devices carried by consumers. The plurality of electronic devices include location/position technology. The system also includes a back-end system, and a front-end interface system communicating with an existing wireless network. The front-end interface system communicates with the plurality of electronic devices carried by consumers for the display of data and potential in-store interaction between the consumer and a product and service company or a retailer.

### CROSS REFERENCE TO RELATED APPLICATION

This application claims the benefit of U.S. Provisional Patent Application Ser. No. 61/728,289, entitled “PROCESS, METHOD, SYSTEM AND APPARATUS FOR ACCESSING CONSUMERS TO IMPROVE SALES, KNOWLEDGE AND ENGAGEMENT,” filed Nov. 20, 2012.

### BACKGROUND OF THE INVENTION

1. Field of the Invention

This invention relates to a process, method, system and apparatus for accessing consumers before, during and after their purchase decisions. In particular, this invention discloses a process for integrating and utilizing a system and apparatus with existing wireless networks and consumer electronic devices to promote products and services while engaging customers and gaining knowledge and data about consumer behavior and preferences.

2. Description of the Related Art

In a world of over seven billion people, there is a tremendous opportunity to sell various products and services. The challenge relates to how a company can best reach the target audience for their goods and services and better engage their customers.

There are at least six major problems that consumer product and service companies face in the current marketplace.

One, An Expanding Borderless Marketplace. The potential market is enormous. In past decades companies could create products for specific geographic locales. For example, a toy company might have produced a stuffed animal in the United States. This company would have advertised in local newspapers and perhaps during Saturday morning cartoons on network television. American children and their parents would have then gone to brick and mortar retailers to buy this particular stuffed toy. There was no chance of any Internet research on the product. Additionally, the product was only marketed and sold in the United States. Today, a product offered in the United States is immediately known to consumers around the world. It is reviewed and offered for resale as quickly as it is produced. Today, an “American” stuffed animal is likely made in China, and immediately purchased online by customers from Argentina to Zaire.

Two, Desensitization To Advertising. Consumers around the world have become somewhat desensitized or immune to traditional advertising. In the modern world it would appear that nearly everyone has attention deficit disorder. People are addicted to urgency and don't have much time for watching advertisements on television or in magazines. Today, the most effective promotions are ones that are targeted and focused. Most people have short attention spans and want relevant information fast.

Three, The Inability To Access Key Decision-Making Information. Consumers do not have the information they sometimes want or need from retailers and consumer product and service companies. While in the comfort of their homes consumers might have time to research products, but while on the go, it is more challenging to get acquainted with products and make knowledgeable purchase decisions. When standing in the store aisle, the consumer needs real time on-line information on critical matters such as nutrition and allergy information. The current programs at the retail level do not address such needs. There is a real dearth of data for the consumer as he or she shops large supermarkets and big box retailers.

Four, Divergent Interests As Between The Retailer, On The One Hand, And The Consumer And Consumer Product And Service Companies, On The Other Hand. Large retailers often have different interests than consumer product and service companies, and the consumers those companies target. In the past, consumer product and service companies have paid retailers large amounts of money to ensure shelf placement and store location. Furthermore, retailers often require their vendors to meet a long list of expensive demands before they are willing to promote a product or service. Massive retailers such as Walmart and Home Depot have only exacerbated this problem. These retailers will not hold the hands of consumer goods and services companies. They simply want low prices and hurried volume. The difference between a product sold by General Mills and one sold by Quaker, for example, might not be important to the big box retailer, but it might be to the consumer in his or her attempts to make an informed purchasing decision.

Five, The Absence Of Real-Time Consumer Data Sharing. Consumer product and service companies do not have enough information about the end-use customer. Again, large retailers don't gather or share much information about their customers—particularly as it relates to individual products and services, and when they do, they certainly do not share this information in real-time. When has a shopper at Walmart been asked why she chose Crest toothpaste versus Colgate? And, even if asked, would the results be provided in a meaningful time frame by today's standards? There is a tremendous amount of data being lost every second around the world as people make purchases.

Six, The Absence Of Real-Time Dialogue With Consumers. Consumer product and service companies have not historically engaged in a real-time dialogue with their customers, nor have they interacted with them about products or services, preferences and methods to entrench customer loyalty. Consumers are often removed from the process during the in-store experience at the point of purchase.

With the foregoing concerns in mind, there have been various attempts to gather market information and improve sales of consumer product and service companies. These attempts have been met with limited success for the following reasons.

1. Many of the solutions have relied on old technologies that were either cumbersome to use or manage. These older technologies did not allow for sufficient data gathering. The associated communication networks or systems were also less than ideal.

2. Some of the solutions were geared toward the retailer and their interests, not the consumer product or service company. So, while the consumer product and service companies might have received some information, the purpose was clearly centered on increasing sales and profits for the retailer—without much emphasis placed on specific vendors or brands.

3. Some of the current mobile phone apps and programs provide additional information but they do not provide the time and place relevancy of our process, method, system and apparatus. For example, perhaps a consumer goods or service company sends an email promo to the smart phone of a potential customer. This could now occur while the recipient is in the shower or otherwise preoccupied.

4. The current services do not involve the user and do not enhance the user's experience. Most current phone or tablet marketing is more of an annoyance and is not geared toward the user's preferences and state of mind.

5. The current apps and marketing programs do not effectively address individual consumer choices, habits and larger patterns of behavior. How can consumer product and service companies gain more information about their customers—particularly non-biased data gathered directly and contemporaneously with the purchase?

### SUMMARY OF THE INVENTION

It is, therefore, an object of the present invention to provide a system for accessing consumers before, during and after purchase decisions. The system includes a plurality of electronic devices carried by consumers. The plurality of electronic devices include location/position technology (including GPS, cellular triangulation, RFID or other methods). The system also includes a back-end system, a front-end interface system communicating with an existing wireless network for communicating with the plurality of electronic devices carried by consumers for the display of data and in-store interactions between the consumer and a product and service company or a retailer.

It is also an object of the present invention to provide a system wherein the electronic devices are tablet computers or smartphones.

It is another object of the present invention to provide a system wherein the front-end interface system is a server.

It is a further object of the present invention to provide a system wherein the back-end system is a server.

It is also an object of the present invention to provide a system wherein the back-end system includes a customized content provisioning system.

It is another object of the present invention to provide a system wherein the customized content provisioning system utilizes location/position technology to isolate exact location of the plurality of electronic devices carried by consumers taking into account proximity to goods being promoted.

It is a further object of the present invention to provide a system including a real-time information and promotions providing system.

It is also an object of the present invention to provide a system wherein the back-end system determines the most desirable content for the consumers.

It is another object of the present invention to provide a system including a feedback providing system providing feedback to the consumer products and/or services company.

It is a further object of the present invention to provide a system including a content creation and management providing system for creation of custom promotional efforts.

It is also an object of the present invention to provide a method for accessing consumers before, during and after purchase decisions. The method includes alerting targeted consumers with electronic devices as to the existence of a promotional system; enrolling the targeted consumers and collecting data identifying the consumers; compiling and organizing the data identifying the consumers; using time and place data, delivering advertisements and promotions to the electronic devices of the consumers at a selected time.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system.

FIG. 2 is a schematic of the network interactions involved in the present system.

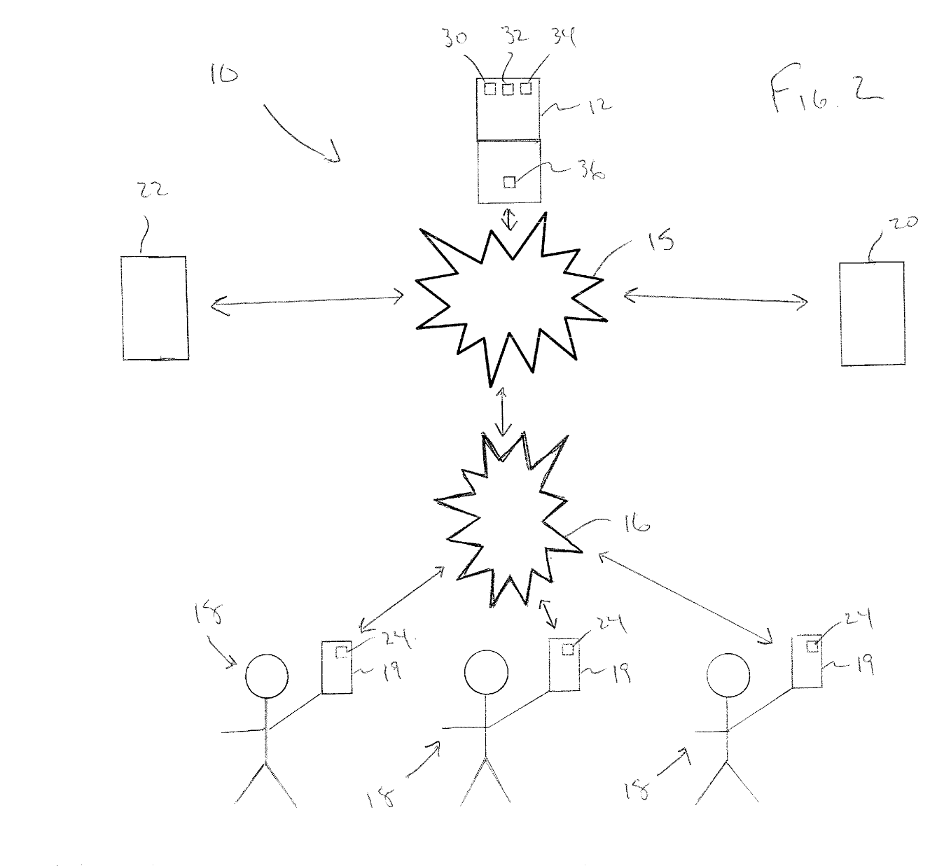

FIG. 3 is a schematic of an implementation of the present system.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

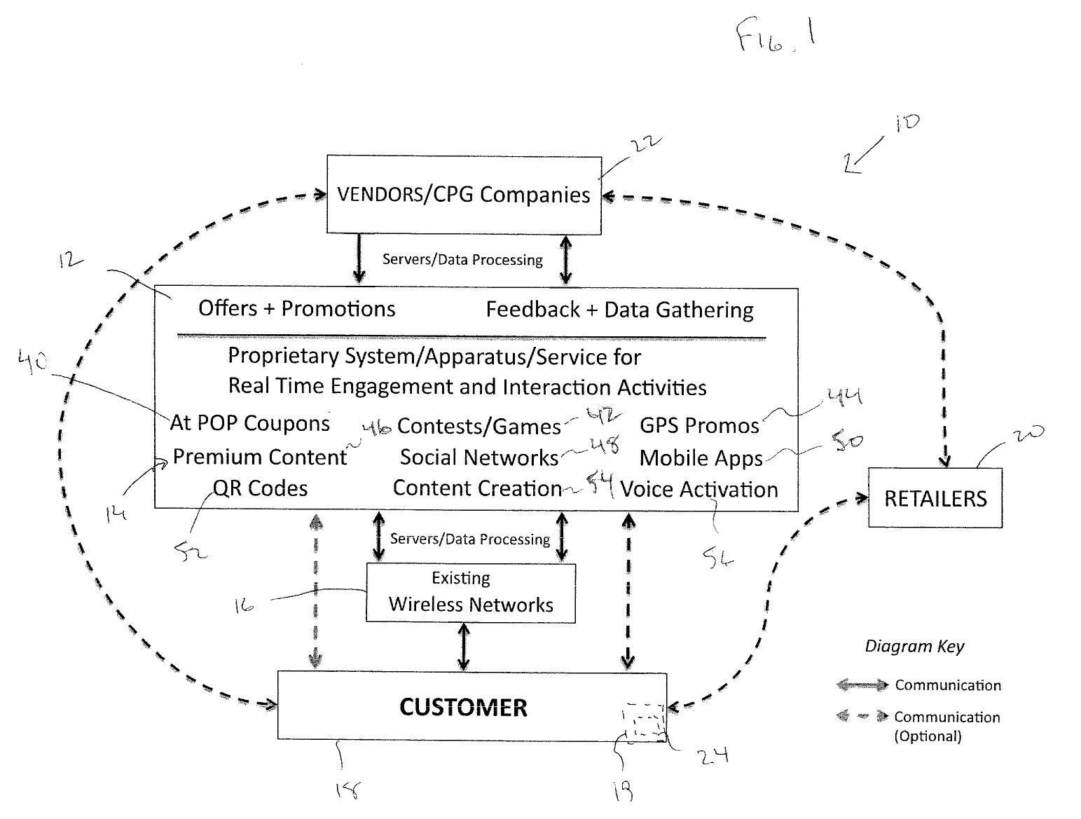

Referring to FIGS. 1 & 2, the present invention provides a system and method for accessing consumers before, during and after their purchase decisions. The present consumer accessing system 10 is a computer implemented communication system including an end-use customer/consumer focused system integrating and utilizing a back-end system 12 with a front-end interface system 14 that communicates with global communication networks (for example, the Internet) and existing wireless networks 16 for communicating with consumer owned electronic devices 19 for the display of data and potential in-store interaction between the consumer (or customer) 18 and the product and service company 22 and/or between the retailer 20 and the consumer 18 and/or between the retailer 20 and the consumer products and/or services company 22. While the consumers 18 will utilize wireless networks 16 to achieve mobile access to the back-end system 12 and front-end interface system 14 of the present system 10, the product and service company 22 and/or the retailer 20 will preferably communicate via the Internet 15 or other global communication networks. As will be appreciated based upon the following disclosure, the front-end interface system 14 provides for the distribution, collection and interaction with a wide variety of electronic media, including, but not limited to POP (point of purchase) coupons 40, contests/games 42, promotions dictated by location/position information 44, premium content 46, social networks 48, mobile apps 50, QR code interfacing 52, content creation 54, and/or voice activation 56.

In accordance with a preferred embodiment, the consumer owned electronic devices 19 contemplated for use in accordance with the present invention include tablet computers, smartphones and other mobile devices which are currently owned and used by consumers. It is, however, appreciated, electronic devices are constantly advancing and these advancements may be integrated for utilization in accordance with the present invention. On the service provider side, that is, the operators and administrators of the back-end system 12 and the front-end interface system 14, and the computer systems of the product and service company(ies) 22 and retailer(s) 20, conventional servers, computers and storage devices are utilized to facilitate both the front-end interface system 14 with which the consumer owner electronic devices communicate and the back-end system 12 processing data necessary for implementation of the present invention as described below in detail. Similarly, the systems of the product and service company(ies) 22 and retailer(s) 20 as used in accordance with the present invention are implemented using conventional servers, computers and storage devices and references to the product and service company(ies) 22 and retailer(s) 20 as employed herein are intended to refer to such servers, computers and storage devices of the product and service company(ies) 22 and retailer(s) 20.

It is appreciated, the consumer owned electronic devices 19 preferably connect with the front-end interface system 14, and ultimately the back-end system 12, via local, regional and international wireless networks 16, as well as global communication networks 15. These wireless networks include mobile data service providers such as T-Mobile or Verizon. As such, these networks also employ numerous technological devices and gear such as computers, servers, landlines, transmission towers and devices as well as satellites and GPS (global positioning system) components. It is appreciated communication may be achieved in a variety of manners combining multiple carriers, including wired and wireless mechanism to achieve communications in accordance with the present invention.

The present consumer accessing system 10 also includes a customized content provisioning system 30 providing customized content to end-use consumers based on real-time wants and needs. The customized content provisioning system 30 includes processing and logic making it possible for consumer goods and services companies to offer real-time and relevant content. The customized content provisioning system 30 forms part of the back-end system 12. The customized content provisioning system 30 utilizes location/position technology (including GPS, cellular triangulation, RFID or other methods) 24 (that is, location/position information coming from the consumer owned electronic device(s) 19) to isolate the exact location of the electronic device 19 carried by the consumer 18 taking into account his or her proximity to the goods being promoted—even within the store itself.

The present consumer accessing system 10 also includes a real-time information and promotions providing system 32 providing information and promotions to the electronic device 19 of the consumer 18 to facilitate awareness and increase sales. The real-time information and promotions providing system 32 also preferably forms part of the back-end system 12. It is also appreciated the real-time information and promotions providing system could include Bluetooth or voice activation equipped products geared for convenience around the time of the shopping experience.

In accordance with a preferred embodiment, using location/position generated location information transmitted from the consumer owned electronic device 19 to the front-end interface system 14, and ultimately the back-end system 12, the present system 10 is able to recognize the exact location of the consumer 18. Once the location of the consumer 18 is determined, the resources of the back-end system 12 determine the most desirable content for that particular consumer 18. Using advanced data processing—to include formulas or algorithms, based on similar customers or even this particular customer—the system 10 generates potential offers to be delivered to the consumer's mobile device 19 within seconds.

The present consumer accessing system 10 also includes a feedback providing system 34 providing feedback to the consumer products and/or services company 22 and/or to the retailer 20 on user preferences, activity and engagement. This feedback is then be used to enhance the entire system, process and method and increase effectiveness. As with the customized content provision system 30 and the real-time information and promotions providing system 32, the feedback providing system 34 also preferably forms part of the back-end system 12. In accordance with a preferred embodiment, the feedback data is analyzed using both automated processes and human interaction. The feedback data is compared with other comments or questions so intelligent responses may be predicted and generated automatically. Once the data is organized, people could observe additional patterns or insights to improve the marketing efforts of the consumer products and/or services company 22 and/or to the retailer 20 through the consumer accessing system 10.

The present consumer accessing system 10 also includes a content creation and management system 36 for creating custom promotional efforts and customer interaction subscribed for by the customers 18, consumer products and/or services companies 22 and/or by retailers 20. The content creation and management system 36 forms part of the front-end system interface 14 as it will be available for access by user of the present system whether they be customers 18, consumer products or services companies 22 and/or by retailers 20.

The entire consumer accessing system 10 is ultimately based on facilitating two-way communication between the consumer 18 and the consumer products and/or services company 22. Consequently, the consumer accessing system 10 naturally solicits feedback and content from its users. Through the displays of the consumer's mobile device 19, he or she would see requests or links for feedback and content. This content could be text, graphics, photos, audio or movies. This data travels through the wireless network 16 to the servers and storage products of the consumer products and/or services company 22. This data is then be processed and sorted (such as grouping text responses together) as desired by the consumer products and/or services company 22. Once organized, the content is reviewed both autonomously and with human interaction. The quality content may be posted or used by the consumer products and/or services company 22 for other users. The use of the information would be governed by an electronic agreement when the consumer registered or sent the content.

Although various embodiments are possible within the proposed invention, the following description presents an exemplary embodiment of a process, system, method and apparatus in accordance with the present invention. A consumer products and/or services company 22 wants to increase its sales at various retail locations. Through the use of the present consumer accessing system 10 the company forms an agreement with a proprietary wireless network provider such as RIM/Blackberry or AT&T. The wireless network company has millions of subscribers who already carry portable electronic devices. In recent years these devices have become capable of displaying vivid colors and dynamic information sources. The quality is nearly as good as, or sometimes better than, devices at home or in the office. Furthermore, the existing secure networks are not being utilized effectively for purposes other than voice and data of existing subscribers. The present consumer accessing system 10 bridges their built-out technology with new customers—namely consumer product and service companies.

The targeted customers 18 of the consumer products and/or services company 22 (and/or the wireless company) are first alerted to the existence of the present consumer accessing system 10. The consumer accessing system 10 is accessed by the consumer 18 (that is, via the electronic device 19) via the consumer's existing wireless network 16 relationship with his or her subscribing wireless provider. The consumer 18 may also utilize another wireless network—perhaps one offered by the retailer, consumer products/services company or another party. The consumer 18 is then asked to subscribe to the consumer accessing system 10 via an online enrollment process. In this process, consumers 18 can identify themselves with various demographic data and select their preferences, within the customizable parameters offered by the system 10.

All of this knowledge and data is then compiled and organized by the consumer accessing system 10. It is contemplated the organization process will be a two-pronged process. The data processing software of the system's back-end system 12 will use formulas and algorithms to sort and rank the data. After automated processing, the data is presented to company employees (preferably via the front-end system interface 14) who will further refine the essential information. This quantitative and qualitative analysis creates profiles for consumers 18. With additional use and more data points, the system 10 learns about the consumer 18 and is able to offer better suggestions and promotions based on known trends and predictable behavior patterns.

Once the data is combined with marketing initiatives having their genesis with the retailer 20, the consumer products and/or services company 22 or the intermediary service provider, the real benefits of this system 10 become clear. As the data picture develops both for individual consumers and larger populations, the consumer products and/or services company 22 could be reactive and proactive. For example, if the data shows people aren't buying laundry detergent before the Super Bowl, the consumer products and/or services company 22 could try to promote this. The consumer products and/or services company 22 might try sending detergent point of purchase coupons 40 around the time the consumer 18 is buying mustard for the big game. Using time and place data, the consumer products and/or services company 22, or the retailer 20, either directly or through an intermediary service provider, delivers point of purchase advertisements and promotions 40 to the end customer 18 at exactly the right time. For example, the previous coupon for laundry detergent 40 could appear on a smart phone 19 just as customers 18, who those who have pre-registered based upon preferences or buying/shopping patterns, enter a grocery store. Better yet, this promo (that is, the coupon for laundry detergent) 40 could appear on a smart phone 19 as the target consumer 18 enters the aisle that contains the desired laundry cleaning products. This would occur through the use of the location/position and RFID (radio frequency identification) technology integrated into the phone, tablet or other electronic device.

Furthermore, the retailer 20 or the consumer goods and/or services company 22 could augment this ability on their own, or through an intermediary service provider. All of the data could be combined, catalogued and maintained in central or dispersed storage devices forming a part of the invention's apparatus. Perhaps the consumer 18 indicated a preference for outdoor activities and camping. The invention could suggest the ingredients for S'mores and even give the customer 18 directions to find them within his or her favorite store—all in real-time.

The consumer access system 10 also facilitates and enhances the ability of consumer products and/or services companies 22 to create interesting and user-engagable premium content 46. For example, a short movie or animation could be created and delivered to customers via smart phones or other electronic devices 19; either directly or via an intermediate service provider. In addition to having a promotional item—such as an electronic coupon or offer, the movie could be entertaining. The entertainment value of quality movies or animations would extend beyond the direct interaction with the customer. It is anticipated that these movies could be cataloged and viewed online—perhaps even on YouTube™. The consumer access system 10 would create “crowd-sourcing” for new promotions created by the targeted consumers 18 themselves. The opportunity for user involvement is almost endless and would likely include contests and various interaction methods that build on the consumer access gained through the proposed consumer access system 10 and could include specific customer imaging and interaction associated with the products.

Once the promotions are offered, crafted and utilized by customer engagement, the consumer products and/or services company 22 and/or the retailer 20 and/or an intermediary service provider, continues to gather data. The company 22 and/or the retailer 20 can then use that data to increase business and the entrenchment of brand loyalty.

Since data storage has become ubiquitous and inexpensive, it makes sense for consumer goods and/or services companies 22 to collect as much data as possible. The present system 10 records consumer time and place data along with purchase decision data and promotion utilization data. This would be sent from the consumer's mobile device 19 through the wireless network 16 to computing and storage centers. In the background the back-end system 12 of the present system 10 continuously runs real-time analysis for immediate use by the consumer products and/or services company 22 and/or the retailer 20. Literally, a coupon sent to 1,000 mobile devices 19 could be changed five minutes later to better accomplish its goal with the next 250,000 consumers.

The combination of numerous users and the nearly unlimited data storage and computer processing power allows for unique software programs for analysis and data modeling to emerge. The present system envisions the use of advanced programming and computational methods such as algorithms to find patterns and improve the intelligence of the system instantaneously. This software is a key component of the disclosed system since it can be updated and modified in real-time.

The entire consumer access system 10 would, therefore, allow real-time knowledge and tweaking of marketing. On the last day of the quarter, a CEO of a consumer products and/or services company 22 could request higher sales for this Wall Street analysts call. This could be accomplished with testing and revisions to mobile promotions that very day.

The consumer products and/or services company 22 or the retailer 20 would obtain immediate results about which email or text worked. The use of bar codes, QR codes 52 and other electronic coupons 40 would provide instant feedback. The companies 22 would also obtain a literal treasure trove of consumer purchase data that could be shared with the retailers 20 or others with the right incentives. These incentives would also be green or environmentally friendly as they would be electronic or virtual by design. The elimination of printed coupons, paper surveys and brochures is helpful in reducing paper consumption and limiting carbon emissions. The electronic or virtual incentives described here also limit the negative effects of coupon fraud and other nefarious activities by unethical parties.

It is also anticipated as a feature of this invention, that the present consumer accessing system 10 would provide benefits to friends and family of the customer 18. In other words, the promotions a consumer 18 selects while in the store could be replicated for his or her friends in real-time. If two women were shopping together for the previously mentioned S'mores, the woman who received the recipe, location information within the store, recommendations or promos could transfer this to her friend. The friend would then also have a coupon for the proper chocolate. Alternatively, the system 10 would be intelligent enough to suggest non-intuitive products that relate to this customer knowledge. For example, the system 10 might offer a promotion for matches or a fire log. The system could also do task-splitting to benefit both customers. Using the previously described example, one of the women might get the complete list for S'mores while her friend would get the related products such as fire logs and matches. This service becomes immediately helpful and functions as an organized party planner. In this way, everyone wins and the consumer goods and/or services company 22 gets another linked-in user and fan. This fan is a great referral source acknowledged for his or her loyalty. Finally, the consumer products and/or services company 22 would have the knowledge to promote non-competing products or services from other non-featured suppliers. They could leverage the retailer's and/or the consumer goods and services company's real-time knowledge and customer relationships to gain additional revenue from these partnerships. Since all of the data is gathered and stored, the development of partnerships would be justified by real data analysis. For example, if a marshmallow company realized that 90 percent of its customers were buying chocolate within five minutes of putting marshmallows into their carts, they could approach chocolate companies about joint-promotion efforts to capitalize on the known purchase relationship.

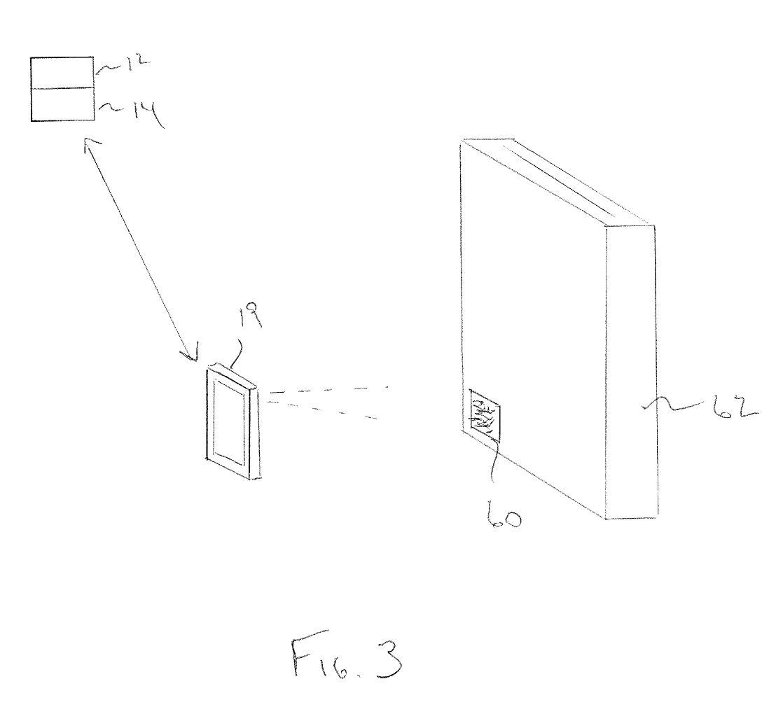

Yet another feature of this invention is that the present consumer accessing system 10 offers the potential for contests and gaming. In the implementation of such a feature, and with reference to FIG. 3, a mobile device 19 could act as a scanner for QR or other informational codes 60 on packages 62 or on in-store POS materials. These codes 60 could lead the consumer 18 to a specific website or online place. This website would then enhance brand awareness—perhaps in the context of a game, trivia or a contest. For example, a consumer might be eating his Wheaties cereal in the morning. The consumer access system 10 envisions a code 60 on the back of the box 62. After reading the back of the box 62, the consumer 18 would hold up his smartphone 19 to the code 60. The consumer 18 would then be transported to the producer's website. This website could then offer a tremendous amount of information, entertainment and engagement. In the case of Wheaties™, it could offer a sports game to coincide with the sports player depicted on the front of the box 62. It could also offer prizes—perhaps tickets to that team's games. This is yet another way for consumer products companies to bypass retailers to communicate more effectively with their end customer.

Yet another feature of this invention is that the process, system, method and apparatus affords the ability for direct and real-time communication of time sensitive and other communications—especially those dealing with socially responsible goals and programs. The QR or other informational code 60 on the back of the cereal box 62 could link to different websites or places depending on real-time objectives and programs. During February, for example, the scanned code could link to heart health efforts or charities. If an issue like school bullying were in the news, a consumer products and/or services company 22 could get out in front of the movement by shifting its social marketing efforts during a specific period. It would certainly allow the company 22 to be more empathetic to trends and customer concerns in a mobile and increasingly aware modern society. This system 10 effectively gives the company 22 the power to reprint its cereal or food box every morning and allows customer 18 engagement that a printing press was never designed to do.

The bottom line advantage for this process, system, method and apparatus is the engagement and interaction between the consumer products and/or services company 22 and their customers 18 and/or between the retailer 20 and the consumer 18 and/or between the consumer 18 and/or between the consumer goods and/or services company 22 and the retailer 20. It effectively bridges the gap between brick and mortar retailing and online retailing. This combination allows additional knowledge and power to reside with the company 22 making the product or service and/or the retailer 20 and the consumer 18 making the purchase decision. The store doesn't even have to know that one of its vendors is directly communicating with their customers in the middle of their shopping experience.

This transfer of knowledge or power ultimately benefits the consumer 18. He or she is now the object of the consumer products and/or services company 22 that is engaged in this process of messaging. The customers 18 are not forgotten in the vendor's desire to please the large retailers 20. This makes good economic and practical sense. Consider a consumer who buys a Sony TV at Walmart. If this customer has a question about the television, he or she would not call Walmart. Most people would acknowledge Walmart is a discount retailer known for low prices but less-than-stellar customer service and product information. The customer 18 would call or email Sony. So, why not enable Sony to communicate with this customer 18 before, during and after the purchase without the involvement or disruption of the retailer—in this case Walmart?

The benefits of this proposed system 10 are enormous. It would provide consumer products and/or services companies 22 with nearly limitless data on how to make, distribute, promote and sell their products and services and to shape their communications with the consumer 18 in order to achieve the same. It would happen seamlessly via a process that integrates and utilizes a system and apparatus with existing wireless networks 16 and consumer electronic technology and under-utilized in-place networks that are ripe for additional interaction among users. It would provide consumers with new real-time information and all of the benefits associated with this fingertip access. It also gives companies a reason to cooperate and explore the benefits of improved customer relations. It is a consumer-centric model in a world where consumers are more empowered than ever by portable electronic devices. Finally, it is sensible solution for security and the environment.

In summary, this invention provides a solution to the current problem of retailers controlling the purchase environment for consumers. It gives consumer product companies the ability to intelligently communicate with their end-use customers directly and provide the associated benefits to them. It generates real-time data that can be mined and analyzed to improve products, increase sales and solidify customer relations while also enabling the customers to be engaged in the interactive messaging process.

While the preferred embodiments have been shown and described, it will be understood that there is no intent to limit the invention by such disclosure, but rather, is intended to cover all modifications and alternate constructions falling within the spirit and scope of the invention.

1. A system for accessing consumers before, during and after purchase decisions, comprising:
a plurality of electronic devices carried by consumers, the plurality of electronic devices including location/position technology;
a back-end system;
a front-end interface system communicating with an existing wireless network for communicating with the plurality of electronic devices carried by consumers for the display of data and potential in-store interaction between the consumer and a product and service company or a retailer.

2. The system according to claim 1, wherein the electronic devices are tablet computers or smartphones.

3. The system according to claim 1, wherein the front-end interface system is a server.

4. The system according to claim 1, wherein the back-end system is a server.

5. The system according to claim 1, wherein the back-end system includes a customized content provisioning system.

6. The system according to claim 1, wherein the customized content provisioning system utilizes location/position technology to isolate exact location of the plurality of electronic devices carried by consumers taking into account proximity to goods being promoted.

7. The system according to claim 1, further including a real-time information and promotions providing system.

8. The system according to claim 1, wherein the back-end system determines the most desirable content for the consumers.

9. The system according to claim 1, further including a feedback providing system providing feedback to the consumer products and/or services company.

10. The system according to claim 1, further including a content creation and management providing system for creation of custom promotional efforts.

11. The system according to claim 1, wherein the front-end interface system and back-end systems employ software and computational programs to analyze data.

12. A method for accessing consumers before, during and after purchase decisions, comprising:
alerting targeted consumers with electronic devices as to the existence of a promotional system;
enrolling the targeted consumers and collecting data identifying the consumers;
compiling and organizing the data identifying the consumers;
using time and place data, delivering advertisements and promotions to the electronic devices of the consumers at a selected time.

13. The method according to claim 11, wherein the electronic devices are tablet computers or smartphones.

14. The method according to claim 11, further including a customized content provisioning system.

15. The method according to claim 14, wherein the customized content provisioning system utilizes location/position technology to isolate exact location of the plurality of electronic devices carried by consumers taking into account proximity to goods being promoted.

16. The method according to claim 11, further including providing real-time information and promotions to the plurality of electronic device carried by consumers to facilitate awareness and increase sales.

17. The method according to claim 11, further including determining most desirable content for the consumers.

18. The method according to claim 11, further including providing feedback to the consumer products and/or services company.

19. The method according to claim 1, further providing for content creation and a management for custom promotional efforts.
